(19) United States
(12) Patent Application Publication
(10) Pub. No.: US 2012/0179999 A1
(43) Pub. Date: Jul. 12, 2012

(54) TOUCH SCREEN USER INTERFACES

(75) Inventors: Christopher D. Nesladek, Mountain View, CA (US); Michael A. Cleron, Menlo Park, CA (US); Daniel R. Sandler, Watertown, MA (US); James E. Palmer, San Jose, CA (US)

(73) Assignee: Google Inc., Mountain View, CA (US)

(21) Appl. No.: 13/249,430

(22) Filed: Sep. 30, 2011

Related U.S. Application Data
(63) Continuation of application No. 13/004,965, filed on Jan. 12, 2011.

(51) Int. Cl. G06F 3/048

(52) U.S. Cl. 715/835

(57) ABSTRACT

Methods, systems, and apparatus, including computer programs encoded on a computer storage medium, for displaying touch screen user interfaces. In one aspect, an electronic device includes one or more data processing devices and a touch screen coupled to the one or more data processing devices to display a user interface under the direction thereof. The user interface includes a first icon representing a relatively broad aspect of the functionality provided by the device, and a collection of three or more icons each representing a different, relatively narrower aspect of the functionality provided by the device. The aspects represented by the three or more icons in the collection are encompassed within the aspect represented by the first icon, the three or more icons arranged generally around the first icon on the touch screen.

### CROSS-REFERENCE TO RELATED APPLICATIONS

This application is a continuation of U.S. application Ser. No. 13/004,965, filed Jan. 12, 2011, the contents of which are incorporated herein by reference.

### BACKGROUND

This specification relates to touch screen user interfaces. People spend hours at a time with their electronic devices—computers, telephones, music players, PDA's, and the like. They like best those devices that are intuitive to use and whose interactions best meet their expectations regarding how machines should work. They interact with electronics through inputs and outputs from the devices. The outputs generally are provided audibly and/or on a graphical display screen. The inputs may occur via touch screens, joysticks, mice, 4-directional keypads, and other such input mechanisms.

Touch screens are graphical display devices that act as both inputs and outputs. In particular, touch screens include a graphical display and detect the presence and location of manual or other physical interaction with that graphical display.

### SUMMARY

This specification describes technologies relating to touch screen user interfaces.

In a first aspect, an electronic device includes one or more data processing devices and a touch screen coupled to the one or more data processing devices to display a user interface under the direction thereof. The user interface includes a first icon representing a relatively broad aspect of the functionality provided by the device, and a collection of three or more icons each representing a different, relatively narrower aspect of the functionality provided by the device. The aspects represented by the three or more icons in the collection are encompassed within the aspect represented by the first icon, the three or more icons arranged generally around the first icon on the touch screen. The one or more data processing devices are programmed to interpret at least some user selections of one of the three or more icons as a command to access the aspect of the functionality represented by the selected one of the icons.

In a second aspect, an electronic device includes one or more data processing devices, a touch screen coupled to the one or more data processing devices to display a user interface under the direction thereof, and a persistent memory comprising one or more data storage devices. The user interface includes a first icon representing an application available on the electronic device and a collection of three or more icons each representing a different task in the application. The persistent memory includes identifiers of the tasks represented by the icons in the collection, identifiers of other tasks in the application, and associated indications of how often the tasks identified by the identifiers were previously accessed. The associated indications indicate that the tasks represented by the icons in the collection were accessed more often than the other tasks in the application.

In a third aspect, a computer storage medium is encoded with a computer program. The program includes instructions that when executed by one or more data processing devices of an electronic device cause the data processing devices to perform operations. The operations include displaying, on a touch screen, interactive icons each representing a different application available on the electronic device, receiving, over the touch screen, a first user selection of a first of the icons representing a first of the applications, in response to the receipt of the first user selection, displaying a collection of three or more icons each representing a different task in the first application, the three or more icons arranged generally around the first icon on the touch screen, receiving, over the touch screen, a second user selection of a second of the icons in the collection, and in response to the receipt of the second user selection, navigating to a user interface of the application for performance of the task represented by the selected icon independently of additional user interaction.

In a fourth aspect, a method is implemented by an electronic device comprising a one or more data processing devices and a touch screen coupled to the one or more data processing devices to display a user interface under the direction thereof. The method includes displaying, on the touch screen, icons, each icon representing a different application available on the electronic device, receiving, over an input device, a first user selection of a first of the icons representing a first of the applications, and determining, using the one or more data processing devices, whether the first user selection is a command to open the first application or whether the first user selection is a command to display additional icons each representing a task within the first application.

The first, the second, the third, the fourth, and other aspects can each include one or more of the following features. A first icon can represent an application that can be performed by the electronic device. Icons in a collection can represent tasks within the application represented by the first icon. One or more data processing devices can be programmed to interpret the at least some user selections as a command to open the application directly to the task represented by the selected one of the icons. A user interface can include a second collection of icons each representing a different, relatively narrower aspect of the functionality provided by the device. Aspects represented by the icons in the second collection can be encompassed within an aspect represented by a respective icon in the collection of three or more icons. The icons in the second collection can be arranged on the touch screen generally around the respective icon in the collection of three or more icons. An electronic device can include a persistent memory comprising one or more data storage devices. The persistent memory can include identifiers of different aspects of functionality offered by the electronic device and associated indications of how often the different aspects of the functionality were previously accessed. Three or more icons in a collection can completely surround a first icon. Three or more icons in a collection can be arranged in a generally arc-shaped perimeter around the first icon. A user interface, under the direction of the one or more data processing devices, can dynamically change to display the icons in the collection moving outwardly away from the first icon. Icons in a collection can be coupled to the first icon by graphical elements. Such graphical elements can be generally branch-shaped and show the icons in the collection germinating from a seminal first icon. A user interface, under the direction of one or more data processing devices, can dynamically change to display one or more new icons. Each of the new icons can represent a relatively narrower aspect of the functionality provided by the device. The aspects of the functionality represented by the new icons can differ from the aspects of the functionality represented by the icons in the collection. One or more data processing devices can be programmed to direct the touch screen to dynamically move the collection of three or more icons outwardly away from the first icon and display new icons representing the other tasks in the application. In response to determining that a first user selection is a command to open a first application, the first application can be opened using one or more data processing devices. In response to determining that a first user selection is a command to display additional icons, a collection of three or more icons each representing a different task in the first application can be displayed on a touch screen. The three or more icons can be arranged on the touch screen generally around the first icon. A second user selection of a second icon in the collection representing a task in the first application can be received over an input device. In response to a user selection, a second collection of icons each representing a different characteristic or feature of the task represented by the selected icon can be displayed on the touch screen. Icons in the second collection can be arranged on the touch screen generally around the selected icon. In response to the second user selection, a user interface of the application for performance of the task represented by the selected icon independently of additional user interaction can be navigated to.

The details of one or more implementations are set forth in the accompanying drawings and the description below. Other features, aspects, and advantages will become apparent from the description, the drawings, and the claims.

### BRIEF DESCRIPTION OF THE DRAWINGS

FIG. 1 is a schematic representation of an electronic device that includes a touch screen.

FIGS. 2, 3, 4 schematically represent example user selections of a first icon in an icon collection.

FIGS. 5, 6 are schematic representations of examples of user interfaces displayed in response to user selection of an icon on a touch screen.

FIGS. 7A, 7B, 7C are schematic representations of an example of a user interface that dynamically changes to present new icons that represent different aspects of the functionality of an electronic device.

FIGS. 8, 9, 10, 11 schematically represent example user selections of an icon that represents an aspect of the functionality of electronic device that is encompassed within the aspect of the functionality represented by the first icon selected by the user.

FIGS. 12, 13, 14 are schematic representations of examples of user interfaces displayed in response to user selection of an icon on a touch screen.

FIG. 15 is a flowchart of a process for determining the likelihood that a user wishes to access an aspect of the functionality provided by an electronic device.

FIG. 16 is a schematic representation of one example of a hierarchical data collection that can store indicators characterizing previous access to the functionality provided by an electronic device.

FIG. 17 is a schematic representation of an example of a user interface to which icons representing high-ranked functionality have been “promoted.”

FIG. 18 is a schematic representation of an example of a user interface displayed in response to user selection of an icon on a touch screen.

FIG. 19 is a schematic representation of a collection of electronic components in a device that can implement touch screen user interfaces.

Like reference numbers and designations in the various drawings indicate like elements.

### DETAILED DESCRIPTION

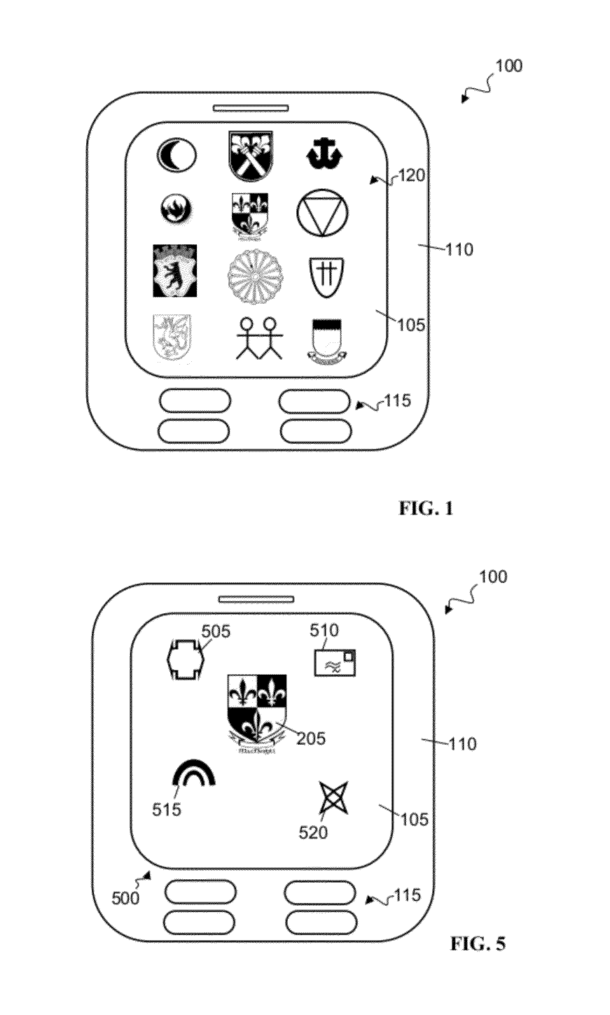

FIG. 1 is a schematic representation of an electronic device 100 that includes a touch screen 105. Electronic device 100 can be, e.g., a computer, a telephone, a smart phone, a music player, a PDA, a gaming device, or the like. In some implementations, electronic device 100 can be mobile, hand-held device. Touch screen 105 is a screen that displays a user interface and can act as both an input and an output. Touch screen 105 can sense the position and movement of one or more of a user's fingers or other elements in close proximity or direct contact (hereinafter “contact”) with the screen. The sensed information can be translated to allow a user to access various functionality provided by electronic device 100. Different categories of electronic devices 100 generally provide different functionality. For example, a music player device 100 may allow a user to view playlists, select music, and the like. A smart phone device 100 may allow a user to organize contacts and contact information, send electronic mail, post to social networks, and the like. User interaction with touchscreen 105 can allow a user to access different aspects of the functionality provided by electronic device 100.

In addition to touch screen 105, electronic device 100 also includes a housing 110 and a collection of off-screen input elements 115. Housing 110 supports touch screen 110 and input elements 115 and houses electronic components. The electronic components not only translate the user interaction with touchscreen 105 for access to different aspects of the functionality provided by electronic device 100, but generally also perform data processing and other operations that provide that functionality. For example, the electronic components can include one or more data processing devices and data communication interfaces that perform smart phone, music player, gaming, or other operations.

Input elements 115 are input devices that can receive input from a user that is distinct from the input received by touch screen 105. Input elements 115 are not part of touch screen 105. In some instances, user interaction with input elements 115 can facilitate user access to or use of the functionality provided by electronic device 100. Input elements 115 can include one or more key, pad, trackball, or other component that receives mechanical, audio, or other input from a user.

In the illustrated implementation, touch screen 105 displays a collection 120 of icons. Icons are graphical or textual indicia and represent different aspects of the functionality provided by electronic device 100. For example, each icon in collection 120 represents a different application available on electronic device 100. An application is a set of computer software that is designed to assist a user in the performance of one or more tasks. Applications can also be referred to as “end-user programs” and are generally self-contained sets of instructions that operate in a non-privileged mode. The icons in collection 120 can represent applications or other aspects of the functionality provided by electronic device 100 graphically (as shown), using text, or using combinations of graphic and textual elements.

In operation, electronic device 100 can receive a user selection of an icon—and the application or other aspect of the functionality represented by that icon. The user selection can be received over touch screen 105, over input elements 115, or over combinations of touch screen 105 and input elements 115. As described further below, electronic device 100 can respond to the user interaction to facilitate navigation not only to a relatively broad aspect of the functionality represented by that icon but also directly to a relatively narrower, more specific aspect that is encompassed within the functionality represented by that icon.

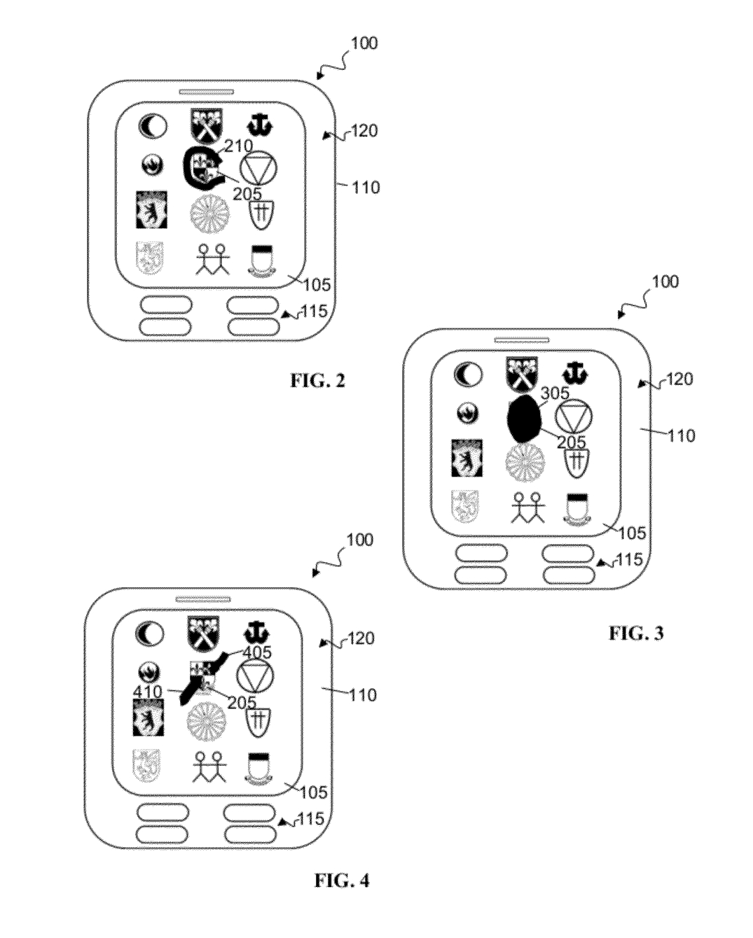

FIGS. 2, 3, 4 schematically represent example user selections of a first icon 205 in icon collection 120. Icon 205 represents a particular aspect of the functionality provided by electronic device 100, such as a particular application. User selection of the icon also selects the represented functionality. In the illustrated implementation, icon 205 is a graphical element, although text icons and icons that combine text and graphical elements can also be used. As described further below, selection of an icon can be interpreted either as a command that the aspect of the functionality represented by the selected icon be accessed or as a command that new icons that represent aspects of functionality encompassed within the functionality represented by the selected icon be displayed.

In FIG. 2, touch screen 105 receives user interaction 210 selecting icon 205. User interaction 210 is represented as a generally circular stroke that encircles at least a portion of icon 205. The stroke of user interaction 210 can be made using the tip of a fingertip or other element. In some implementations, the stroke of user interaction 210 is displayed on touch screen 110. In other implementations, the stroke of user interaction 210 is not displayed. In either case, information characterizing the stroke of user interaction 210 is collected and translated by electronic device 100 into a selection of icon 205.

In FIG. 3, touch screen 105 receives user interaction 305 selecting icon 205. User interaction 305 is represented as a generally fingertip-shaped contact with at least a portion of icon 205. The contact can be made using the tip of a fingertip or other element and can be relatively short in duration (i.e., a “tap gesture”) or relatively long in duration (e.g., a “tap and hold gesture”). In some implementations, the contact of user interaction 305 is displayed on touch screen 110. In other implementations, the contact of user interaction 305 is not displayed. In either case, information characterizing the contact of user interaction 305 is collected and translated by electronic device 100 into a selection of icon 205.

In FIG. 4, touch screen 105 receives user interactions 405, 410 selecting icon 205. User interaction 405 is represented as a first generally line-shaped stroke in a first direction away from the center of icon 205. User interaction 410 is represented as a second generally line-shaped stroke in a second direction away from the center of icon 205. The direction of user interaction 405 can be generally opposite to the direction of user interaction 410 so that user interactions 405, 410 together form an expand gesture. The stroke of user interactions 405, 410 can be made, e.g., using the tips of a thumb and a finger. In some implementations, the strokes of user interactions 405, 410 are displayed on touch screen 110. In other implementations, the strokes of user interactions 405, 410 are not displayed. In either case, information characterizing the strokes of user interactions 405, 410 are collected and translated by electronic device 100 into a selection of icon 205.

In many currently available devices, user interaction selecting an icon that represents an aspect of the functionality of a device navigates directly to the represented aspect of the functionality. For example, many devices respond to user interaction with an icon that represents an application by launching the represented application. As another example, devices can respond to user interaction with an icon that represents a media file (e.g., a photo, an electronic document, a song, an electronic mail or text message, a music file, or the like) by opening that media file in an application that supports the media file.

In contrast, this specification describes technologies that interpret at least some user selections of an icon that represents an aspect of the functionality of a device as a command that a menu of icons representing relatively narrower, more specific aspects of the functionality of the device be displayed. These more specific aspects are encompassed within the aspect of the functionality represented by the selected icon. The icons representing these relatively narrower, more specific aspects can facilitate user navigation directly to a relatively narrower, more specific aspect, as described further below.

FIG. 5 is a schematic representation of an example of a user interface 500 displayed in response to user selection of icon 205 on touch screen 105. The user selection can be received over touch screen 105, over one or more input devices 115, or over combinations of touch screen 105 and one or more input devices 115. For example, the user interaction can be one of user interaction 210, 305, 405, 410 (FIGS. 2, 3, 4). Icon 205 can represent, e.g., an application or other aspect of the functionality provided by electronic device 100. User interface 500 is displayed by touchscreen 105 under the direction of electronic components housed in housing 110. The electronic components can include a data processing device that performs data processing operations, including directing touchscreen 105 to display user interface 500.

In addition to icon 205, user interface 500 also includes a collection of icons 505, 510, 515, 520. Icons 505, 510, 515, 520 each represent an aspect of the functionality provided by electronic device 100. The aspects represented by icons 505, 510, 515, 520 are encompassed within the aspect of the functionality represented by icon 205. Icons 505, 510, 515, 520 can thus represent more specific, narrower instances of the relatively broader functionality represented by icon 205. For example, in implementations where icon 205 represents an application, icons 505, 510, 515, 520 can represent tasks with which the application is designed to assist a user. As another example, in implementations where icon 205 represents a task within an application, icons 505, 510, 515, 520 can each represent different characteristics of performances of the task.

As yet another example, in implementations where icon 205 represents a type of media file (e.g., a image, an electronic document, an electronic mail or text message, a video or music file, or the like), icons 505, 510, 515, 520 can represent functionality provided by electronic device 100 that is relevant to that media file type. For example, icons 505, 510, 515, 520 can represent add to queue, add to playlist, transport controls (e.g., play, pause, skip, stop, etc.), and/or other controls when icon 205 represents a video or music file. As another example, icons 505, 510, 515, 520 can represent open, thumbnail, mark as favorite, add to collection, or other controls when icon 205 represents an image file. As yet another example, icons 505, 510, 515, 520 can represent open, delete, reply, forward, and/or other controls when icon 205 represents an electronic mail or text message.

As yet another example, in implementations where icon 205 represents a contact, icons 505, 510, 515, 520 can represent functionality provided by electronic device 100 that is relevant to the one or more individuals represented within electronic device 100 by that contact. For example, icons 505, 510, 515, 520 can represent various approaches to interacting socially with the contact (e.g., electronic mail, telephone, text messaging, and social networking), obtaining location or other status updates about the contact, locating the contact on a map, and/or other controls. In some implementations, icon 205 can be a photographic or image representing the contact.

Icons 505, 510, 515, 520 are arranged on touch screen 105 around icon 205. In some implementations, icons 505, 510, 515, 520 can surround icon 205 completely and can be found both to the left and the right, and above and below, icon 205. However, this is not necessarily the case. For example, in instances where a user selects an icon that is adjacent an edge of display screen 105, then icons such as icons 505, 510, 515, 520 can form a generally arc-shaped perimeter around the selected icon. As another example, in some instances there may be too few icons to completely surround a selected icon. In any case, the user-selected icon (e.g., icon 205) can be intuitively understood by a user as a seminal (i.e., seed-like) icon from which icons such as icons 505, 510, 515, 520 extend.

In addition to the arrangement of icons 505, 510, 515, 520 on touch screen 105, other graphical elements can be used to indicate that the aspects of the functionality represented by icons 505, 510, 515, 520 are encompassed within the aspect of the functionality represented by icon 205. For example, in some implementations, icon 205 can be enlarged in size relative to its size prior to selection from collection 120, relative to icons 505, 510, 515, 520, or relative to both (as shown). In other implementations, icon 205 can be highlighted, colored, or otherwise labeled relative to its state prior to selection from collection 120, relative to icons 505, 510, 515, 520, or relative to both.

As another example, the display of other icons in collection 120 can be changed to ensure that this encompassment is visually apparent to a user. For example, the other icons in collection 120 can be omitted from user interface 500 (as shown). In other implementations, other icons in collection 120 can be shaded, colored, reduce in size, or otherwise labeled to indicate that the aspects of the functionality represented by icons 505, 510, 515, 520 are indeed encompassed within the aspect of the functionality represented by icon 205 rather than those other icons in collection 120.

In some implementations, user interface 500 can dynamically change to indicate that the aspects of the functionality represented by icons 505, 510, 515, 520 are encompassed within the aspect of the functionality represented by icon 205. For example, icons 505, 510, 515, 520 can appear to originate from icon 205 and move to positions arranged around icon 205. In some implementations, icons 505, 510, 515, 520 can increase in size as they move further away from icon 205.

In some implementations, user interface 500 can dynamically change to present new icons that represent different aspects of the functionality of electronic device 100 that are encompassed within the aspect of the functionality represented by icon 205, as described further below.

In general, the encompassed aspects of the functionality that are represented by icons (e.g., icons 505, 510, 515, 520) are selected by electronic device 100 for display based on the likelihood that the user wishes to access the respective encompassed aspects of the functionality, as described further below.

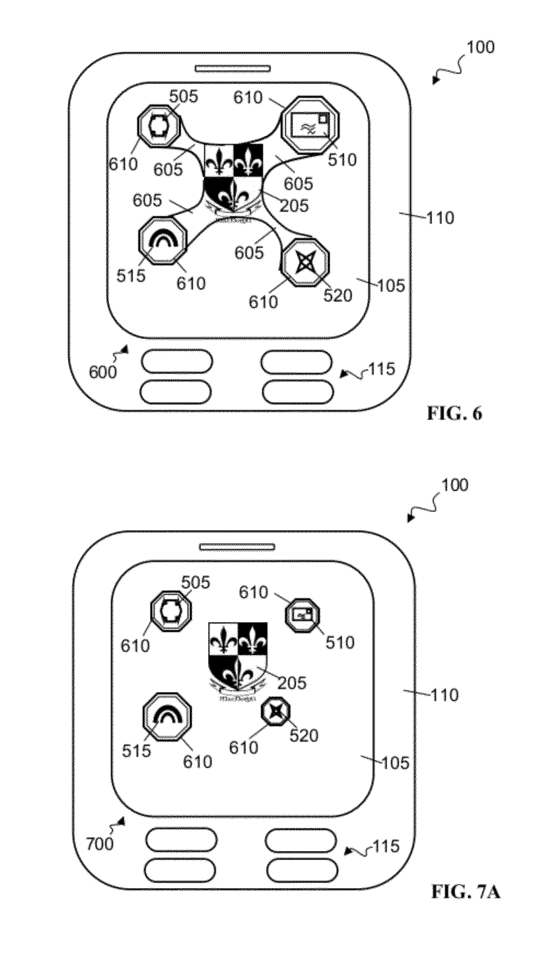

FIG. 6 is a schematic representation of an example of a user interface 600 displayed in response to user selection of icon 205 on touch screen 105. The user selection can be received over touch screen 105, over one or more input devices 115, or over combinations of touch screen 105 and one or more input devices 115. For example, the user interaction can be one of user interaction 210, 305, 405, 410 (FIGS. 2, 3, 4). Icon 205 can represent, e.g., an application or other aspect of the functionality provided by electronic device 100. User interface 600 is displayed by touchscreen 105 under the direction of electronic components housed in housing 110. The electronic components can include a data processing device that performs data processing operations, including directing touchscreen 105 to display user interface 600.

In addition to icon 205 and icons 505, 510, 515, 520, user interface 600 also includes a collection of tendrils 605. Tendrils 605 are graphical elements that couple icons 505, 510, 515, 520 to icon 205 to visually represent that the aspects of the functionality represented by icons 505, 510, 515, 520 are encompassed within the aspect of the functionality represented by icon 205. In the illustrated implementation, tendrils 605 are generally vine- or branch-shaped and germinate from icon 205 and terminate in regions defined by borders 610. In other implementations, tendrils 605 can resemble leaves or petals that germinate from icon 205. Borders 610 enclose icons 505, 510, 515, 520 and demarcate icons 505, 510, 515, 520 from the remainder of user interface 600. In other implementations, tendrils 605 can have other forms and can resemble, e.g., lines, branches, or other graphical elements. Borders 610 also need not be octagonally-shaped as shown but rather can have different shapes, including smooth, leaf or petal shapes that are consistent with plant-shaped tendrils 605.

In some implementations, user interface 600 can dynamically change to represent tendrils 605, and their respective icons 505, 510, 515, 520 sprouting outward from icon 205. In some implementations, tendrils 605 and icons 505, 510, 515, 520 can increase in size as they move further away from icon 205. In some implementations, tendrils 605 and other aspects of user interface 500 can dynamically change to present new icons that represent different aspects of the functionality of electronic device 100 that are encompassed within the aspect of the functionality represented by icon 205, as described further below.

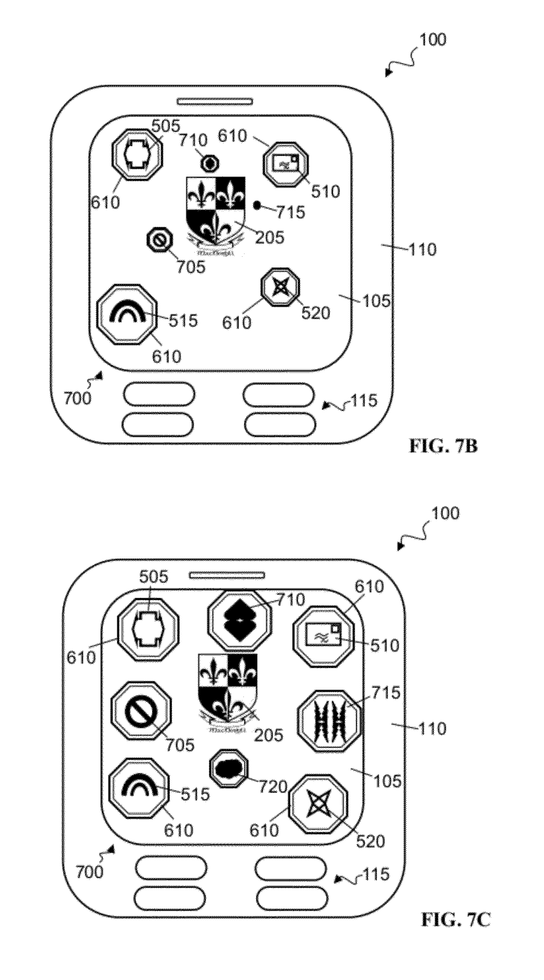

FIGS. 7A, 7B, 7C are schematic representations of an example of a user interface 700 that dynamically changes to present new icons that represent different aspects of the functionality of electronic device 100 that are encompassed within the aspect of the functionality represented by icon 205. User interface 700 is displayed in response to user interaction selecting icon 205 on touch screen 105. The user interaction can be received over touch screen 105, over one or more input devices 115, or over combinations of touch screen 105 and one or more input devices 115. For example, the user interaction can be one of user interaction 210, 305, 405, 410 (FIGS. 2, 3, 4). Icon 205 can represent, e.g., an application or other aspect of the functionality provided by electronic device 100. User interface 700 is displayed by touchscreen 105 under the direction of electronic components housed in housing 110. The electronic components can include a data processing device that performs data processing operations, including directing touchscreen 105 to display user interface 700.

As shown in FIG. 7A, user interface 700 can include icons 505, 510, 515, 520 that move outward from icon 205. In the illustrated implementation, icons 505, 510, 515, 520 (and any borders 610) increase in size as distance from icon 205 increases. The rate or rates at which icons 505, 510, 515, 520 move can be selected to allow a user to review icons 505, 510, 515, 520, determine whether access to the encompassed functionality represented by those icons is desired, and select the icon as appropriate.

As shown in FIG. 7B, icons 505, 510, 515, 520 can continue to move outward from icon 205, increasing in size as distance from icon 205 increases. At some point, new icons 705, 710, 715 are displayed on user interface 700 and move outward from icon 205, increasing in size as distance from icon 205 increases. Icons 705, 710, 715 represent additional aspects of the functionality of electronic device 100 that are encompassed within the aspect of the functionality represented by icon 205 but differ from the aspects represented by icons 505, 510, 515, 520.

As shown in FIG. 7C, icons 505, 510, 515, 520, 705, 710, 715 can continue to move outward from icon 205, increasing in size as distance from icons 205 increases. One or more additional new icons 720 can be displayed on user interface 700 and move outward from icon 205, increasing in size as distance from icon 205 increases.

In some implementations, icons 505, 510, 515, 520 may increase in size initially in close proximity to icon 205 until icons 505, 510, 515, 520 reach “full size.” Such icons 505, 510, 515, 520 can continue to move outward from icon 205 without further changes in size. In other implementations, icons 505, 510, 515, 520 do not increase in size at all but rather appear to germinate from icon 205 full sized.

In some implementations, user interface 700 can continuously display additional new icons. If needed, any of a variety of different approaches can be used to make a portion of touchscreen 105 available to display the additional new icons. For example, in some implementations, icons which have been displayed for relatively longer times can appear to move off user interface 700 (i.e., move off screen). As another example, icons which have been displayed for relatively longer times can appear to decrease in size (e.g., appearing to “wither”) and in some implementations may eventually disappear from view. As yet another example, icons which have been displayed for relatively longer times can be packed relatively closer together and/or overlapped. As yet another example, combinations of these and other approaches can be used.

In general, the encompassed aspects of the functionality that are represented by icons (e.g., icons 505, 510, 515, 520, 705, 710, 715, 720), and the order in which the icons appear, is based on the likelihood that the user wishes to access the respectively represented aspect of the functionality. For example, in the context of the illustrated implementation of user interface 700, icon 515 can represent an aspect of the functionality of electronic device 100 that relatively more likely to be accessed by a user, whereas icon 720 can represent an aspect of the functionality of electronic device 100 that relatively less likely to be accessed by the user. Icons 505, 510, 520, 705, 710, 715 can represent aspects of the functionality with intermediate likelihoods of being accessed.

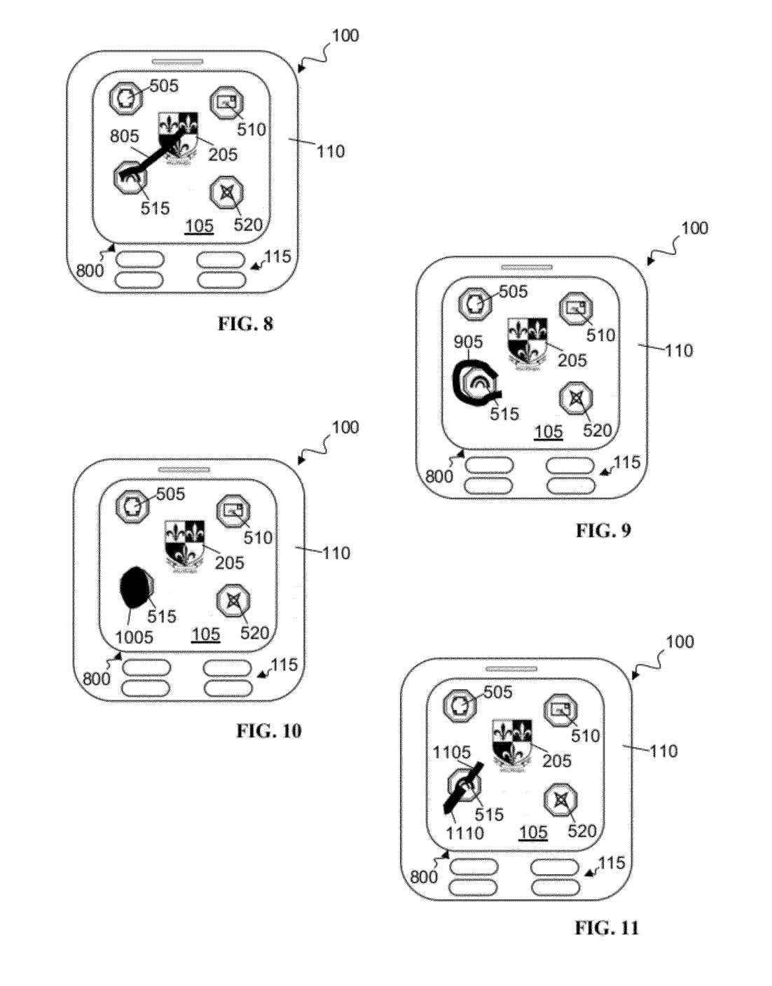

FIGS. 8, 9, 10, 11 schematically represent example user selections of an icon that represents an aspect of the functionality of electronic device 100 that is encompassed within the aspect of the functionality represented by the first icon selected by the user. User selection of the icon also selects the represented encompassed functionality. In the illustrated examples, the first user selection always selects icon 205 and the second user selection always selects icon 515. Other combinatorial permutations of user selections of other icons can be handled by electronic device 100 accordingly. Icon 515 can represent, e.g., a particular task that is performed by an application represented by icon 205. In the illustrated implementation, icon 515 is a graphical element, although text icons and icons that combine text and graphical elements can also be used. As described further below, selection of an icon can be interpreted either as a command that the aspect of the functionality represented by the selected icon be accessed or as a command that new icons that represent aspects of the functionality encompassed within the functionality represented by the selected icon be displayed.

In FIG. 8, touch screen 105 receives user interaction 805 selecting icon 515. User interaction 805 is represented as a generally line-shaped stroke that is drawn from icon 205 to icon 515. User interaction 805 can thus follow user interactions that require a user “hold” icon 205 to select it, such as the “tap and hold” gesture of FIG. 3. The stroke of user interaction 805 can be made using the tip of a fingertip or other element. In some implementations, the stroke of user interaction 805 is displayed on touch screen 110. In other implementations, the stroke of user interaction 805 is not displayed. In either case, information characterizing the stroke of user interaction 805 is collected and translated by electronic device 100 into a selection of icon 515.

In FIG. 9, touch screen 105 receives user interaction 905 selecting icon 515. User interaction 905 is represented as a generally circular stroke that encircles at least a portion of icon 515. The stroke of user interaction 905 can be made using the tip of a fingertip or other element. In some implementations, the stroke of user interaction 905 is displayed on touch screen 110. In other implementations, the stroke of user interaction 905 is not displayed. In either case, information characterizing the stroke of user interaction 905 is collected and translated by electronic device 100 into a selection of icon 515.

In FIG. 10, touch screen 105 receives user interaction 1005 selecting icon 515. User interaction 1005 is represented as a generally fingertip-shaped contact with at least a portion of icon 515. The contact can be made using the tip of a fingertip or other element and can be relatively short in duration (i.e., a “tap gesture”) or relatively long in duration (e.g., a “tap and hold gesture”). In some implementations, the contact of user interaction 1005 is displayed on touch screen 110. In other implementations, the contact of user interaction 1005 is not displayed. In either case, information characterizing the contact of user interaction 1005 is collected and translated by electronic device 100 into a selection of icon 515.

In FIG. 11, touch screen 105 receives user interactions 1105, 1110 selecting icon 515. User interaction 1105 is represented as a first generally line-shaped stroke in a first direction away from the center of icon 515. User interaction 1110 is represented as a second generally line-shaped stroke in a second direction away from the center of icon 515. The direction of user interaction 1105 can be generally opposite to the direction of user interaction 1110 so that user interactions 1105, 1110 together form an expand gesture. The stroke of user interactions 1105, 1110 can be made, e.g., using the tips of a thumb and a fingertip. In some implementations, the strokes of user interactions 405, 410 are displayed on touch screen 110. In other implementations, the strokes of user interactions 405, 410 are not displayed. In either case, information characterizing the strokes of user interactions 405, 410 is collected and translated by electronic device 100 into a selection of icon 515.

In operation, user selection of an icon 505, 510, 515, 520, 705, 710, 715, 720 can be translated by electronic device 100, which can respond accordingly. For example, some user selections can be interpreted by electronic device 100 as a command that the aspect of the functionality represented by the selected icon 505, 510, 515, 520, 705, 710, 715, 720 be accessed. Other user selections can be interpreted as a command that new icons that represent aspects of functionality encompassed within the functionality represented by the selected icon 505, 510, 515, 520, 705, 710, 715, 720 be displayed.

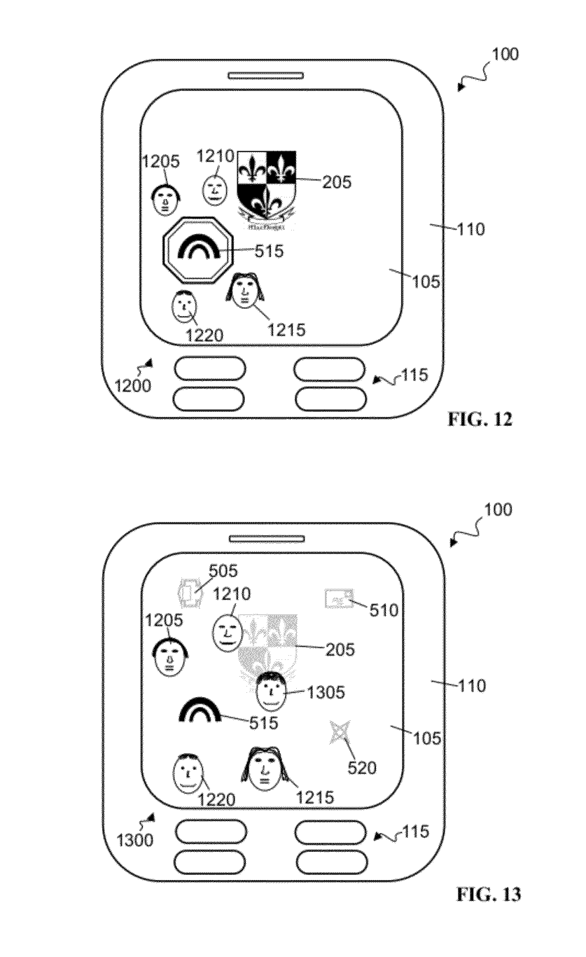

A determination of how the user selection is to be interpreted can be made, e.g., by an input translator of electronic device 100, as described further below. For example, in some implementations, a tap gesture selection of an icon 505, 510, 515, 520, 705, 710, 715, 720 that represents a task within an application can be interpreted as a command that the application be opened and a screen for performing the task within the application be displayed. As another example, in some implementations, a tap and hold gesture selection of an icon 505, 510, 515, 520, 705, 710, 715, 720 that represents a characteristic of a task within an application can be interpreted as a command that new icons that represent aspects of functionality encompassed within the functionality represented by the selected icon 505, 510, 515, 520, 705, 710, 715, 720 be displayed, as described below in FIGS. 12, 13.

Such access to aspects of the functionality provided by electronic device 100 can facilitate user interaction with electronic device 100. For example, users can navigate directly to the desired functionality, e.g., without intermediate steps. Moreover, a user can “drill down” into the functionality provided by electronic device 100 to the extent desired relatively easily. Further, user interfaces and the aspects of the functionality that are represented by icons can be personalized to a particular individual, as described further below. For example, icons that represent aspects that are relatively more likely to be accessed by an individual can be displayed first or in positions with higher priority than icons representing aspects that are relatively less likely to be accessed by that same individual.

Example responses to user interaction (such as, e.g., user interaction 805, 905, 1005, 1105, 1110) selecting icons (such as, e.g., of icons 505, 510, 515, 520, 705, 710, 715, 720) that represent encompassed aspects of the functionality of a device are now described. In these responses, the device responds to the user interaction to facilitate navigation not only to the represented encompassed aspect of the functionality, but also directly to a yet narrower, more specific aspect that is itself encompassed within the encompassed aspect of the functionality.

FIG. 12 is a schematic representation of an example of a user interface 1200 displayed in response to user selection of icon 515 on touch screen 105. The user selection can be received over touch screen 105, over one or more input devices 115, or over combinations of touch screen 105 and one or more input devices 115. For example, the user interaction can be one of user interaction 805, 905, 1005, 1105, 1110 (FIGS. 8, 9, 10, 11). Icon 515 can represent, e.g., a task or other aspect of the functionality provided by electronic device 100 that is encompassed within the functionality represented by icon 205, which itself was previously selected by user interaction. User interface 1200 is displayed by touchscreen 105 under the direction of electronic components housed in housing 110. The electronic components can include a data processing device that performs data processing operations, including directing touchscreen 105 to display user interface 1200.

In addition to icon 515, user interface 1200 also includes a collection of icons 1205, 1210, 1215, 1220. Icons 1205, 1210, 1215, 1220 each represent an aspect of the functionality provided by electronic device 100. However, the aspects represented by 1205, 1210, 1215, 1220 are encompassed both within the aspect of the functionality represented by icon 205 and within the aspect of the functionality represented by icon 515. Icons 1205, 1210, 1215, 1220 can thus represent more specific, narrower instances of the relatively broader functionality represented by icons 205, 515. For example, in implementations where icon 205 represents an application and icon 515 represents a task within that application, icons 1205, 1210, 1215, 1220 can each represent particular characteristics or features of a performance of that task within that application.

Icons 1205, 1210, 1215, 1220 are arranged on touch screen 105 around icon 515. In some implementations, icons 1205, 1210, 1215, 1220 can surround icon 515 completely. In other instances, icons 1205, 1210, 1215, 1220 can form a generally arc-shaped perimeter around the selected icon 515 (as shown). In some implementations, user interface 1200 can include tendrils that couple icons 1205, 1210, 1215, 1220 to icon 515 to visually represent that the aspects of the functionality represented by icons 1205, 1210, 1215, 1220 are encompassed within the aspect of the functionality represented by icon 515. In any case, icon 515 can be taken by a user as a seminal icon from which icons such as icons 1205, 1210, 1215, 1220 descend.

In addition to the arrangement of icons 1205, 1210, 1215, 1220 on touch screen 105, other graphical elements can be used to indicate that the aspects of the functionality represented by icons 1205, 1210, 1215, 1220 are encompassed within the aspect of the functionality represented by icons 205, 515. For example, in some implementations, icons 205, 515 can be enlarged in size relative to their size prior to selection, relative to other icons, or relative to both. In other implementations, icons 205, 515 can be highlighted, colored, or otherwise labeled relative to their state prior to selection, relative to other icons, or relative to both.

As another example, the display of other icons on touchscreen 105 can be changed to ensure that this encompassment is visually apparent to a user. For example, icons 505, 510, 520 can be omitted from user interface 500 (as shown). In other implementations, icons 505, 510, 520 can be shaded, colored, reduce in size, or otherwise labeled to indicate that the aspects of the functionality represented by icons 1205, 1210, 1215, 1220 are indeed encompassed within the aspect of the functionality represented by icons 205, 515.

In some implementations, user interface 1200 can dynamically change to indicate that the aspects of the functionality represented by icons 1205, 1210, 1215, 1220 are encompassed within the aspect of the functionality represented by icons 205, 515. For example, icons 1205, 1210, 1215, 1220 can appear to originate from icon 515 and move to positions arranged around icon 515. In some implementations, icons 1205, 1210, 1215, 1220 can increase in size as they move further away from icon 515 and/or decrease in size, as discussed above.

In some implementations, user interface 1200 can dynamically change to present new icons that represent different aspects of the functionality of electronic device 100 that are encompassed within the aspect of the functionality represented by icons 205, 515.

In the illustrated implementation, icons 1205, 1210, 1215, 1220 are graphical elements that resemble and represent different contacts of the user. Selection of a particular icon 1205, 1210, 1215, 1220 can be translated by electronic device 100 into an indication that the user wishes to, e.g., perform the task represented by icon 515 in the application represented by icon 205 with respect to the individual represented by the selected of icons 1205, 1210, 1215, 1220.

In the illustrated implementation, user interface 1200 also displays icon 205. Display of both icons 205 and icon 515 provides a user with a hierarchical perspective on the currently-selected functionality. In other implementations, icon 205 can be omitted from user interface 1200 or repositioned to accommodate icons such as icons 1205, 1210, 1215, 1220.

In general, the encompassed aspects of the functionality that are represented by icons (e.g., icons 1205, 1210, 1215, 1220) are selected by electronic device 100 for display based on the likelihood that the user wishes to access the respective encompassed aspects of the functionality, as described further below.

FIG. 13 is a schematic representation of an example of a user interface 1300 displayed in response to user selection of icon 515 on touch screen 105. The user selection can be received over touch screen 105, over one or more input devices 115, or over combinations of touch screen 105 and one or more input devices 115. For example, the user interaction can be one of user interaction 805, 905, 1005, 1105, 1110 (FIGS. 8, 9, 10, 11). Icon 515 can represent, e.g., a task or other aspect of the functionality provided by electronic device 100 that is encompassed within the functionality represented by icon 205, which itself was previously selected by user interaction. User interface 1300 is displayed by touchscreen 105 under the direction of electronic components housed in housing 110. The electronic components can include a data processing device that performs data processing operations, including directing touchscreen 105 to display user interface 1300.

In addition to icon 515 and icons 1205, 1210, 1215, 1220, user interface 1300 also includes a new icon 1305 and versions of icons 505, 510, 520, 205 that have been labeled to indicate that the aspects of the functionality represented by icons 1205, 1210, 1215, 1220, 1305 are encompassed within the aspect of the functionality represented by icon 515. Icons 505, 510, 520, 205 are labeled by shading, coloring, reduced size, or otherwise. In other implementations, icon 205 is not labeled or labeled differently from icons 505, 510, 520 to indicate that the functionality represented by icons 1205, 1210, 1215, 1220, 1305 is encompassed within the aspect of the functionality represented by both icons 515, 205. In some implementations, user interface 1300 can include tendrils that couple icons 1205, 1210, 1215, 1220, 1305 to icon 515 to visually represent that the aspects of the functionality represented by icons 1205, 1210, 1215, 1220, 1305 are encompassed within the aspect of the functionality represented by icon 515

As shown, the labeling of icons 505, 510, 520, 205 can be used to accommodate icons 1205, 1210, 1215, 1220, 1305 on touchscreen 105. For example, icons 1210, 1305 can overlap with labeled icons 505, 510, 520, 205 but yet visually distinguished.

In some implementations, user interface 1200 can dynamically change to represent icons 1205, 1210, 1215, 1220, 1305 moving outward from icon 515, to make a portion of touchscreen 105 available to display additional icons, or both.

A user can select a desired icon 1205, 1210, 1215, 1220, 1305, and the functionality represented by the icon, in a variety of different ways, including, e.g., drawing a line-shaped stroke from icon 515 to the selected icon 1205, 1210, 1215, 1220, 1305, drawing a circular stroke that encircles at least a portion of the selected icon 1205, 1210, 1215, 1220, 1305, making contact with at least a portion of the selected icon 1205, 1210, 1215, 1220, 1305, or forming an expand gesture on the selected icon 1205, 1210, 1215, 1220, 1305.

In operation, user selection of an icon 1205, 1210, 1215, 1220, 1305 can be translated by electronic device 100, which can respond accordingly. For example, some user selections can be interpreted by electronic device 100 as either a command that the aspect of the functionality represented by the selected icon 1205, 1210, 1215, 1220, 1305 be accessed or as a command that new icons that represent aspects of functionality encompassed within the functionality represented by the selected icon 1205, 1210, 1215, 1220, 1305 be displayed.

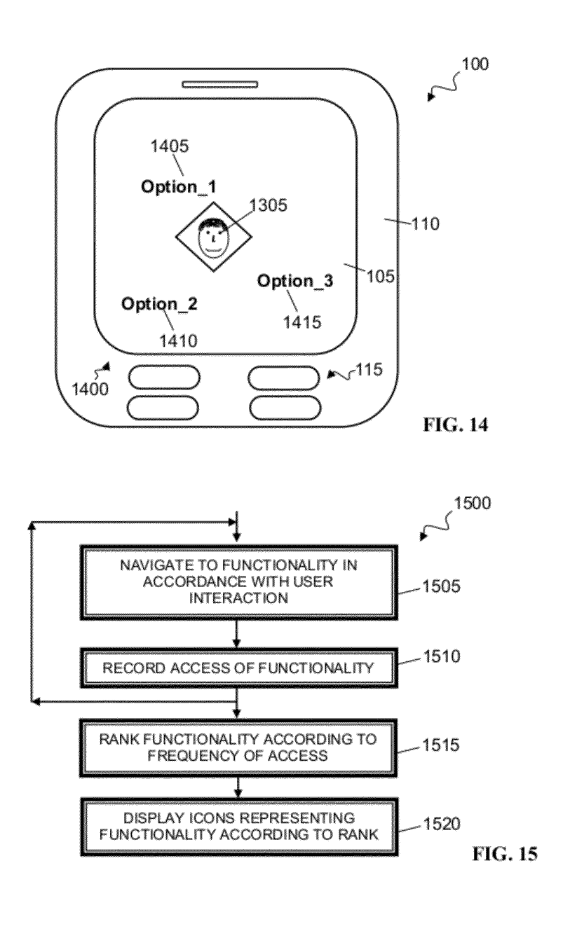

For example, a selection of an icon 1205, 1210, 1215, 1220, 1305 that represents a task within an application can be interpreted as a command that the application be opened and a screen for performing the task within the application be displayed. As another example, a selection of an icon 1205, 1210, 1215, 1220, 1305 that represents a characteristic of a task within an application can be interpreted as a command that the application be opened and a screen for performing the task with the selected characteristic within the application be displayed. An example of the display of new icons that represent aspects of functionality encompassed within the functionality represented by the selected icon 1205, 1210, 1215, 1220, 1305 be displayed are provided below in FIG. 14.

Such access to aspects of the functionality provided by electronic device 100 can facilitate user interaction with electronic device 100. For example, users can navigate directly to the desired functionality, e.g., without intermediate steps. Moreover, a user can “drill down” into the functionality provided by electronic device 100 relatively easily, to the extent desired. Further, user interfaces and the aspects of the functionality that are represented by icons can be personalized to a particular individual, as described further below. For example, icons that represent aspects that are relatively more likely to be accessed by an individual can be displayed first or in positions with higher priority than icons representing aspects that are relatively less likely to be accessed by that same individual.

FIG. 14 is a schematic representation of an example of a user interface 1400 displayed in response to user selection of icon 1305 on touch screen 105. The user selection can be received over touch screen 105, over one or more input devices 115, or over combinations of touch screen 105 and one or more input devices 115. The user interaction can be, e.g., drawing a line-shaped stroke from icon 515 to icon 1305, drawing a circular stroke that encircles at least a portion of icon 1305, making contact with at least a portion of icon 1305, forming an expand gesture on icon 1305, or another user interaction. Icon 1305 represents an aspect of the functionality provided by electronic device 100 that is encompassed within the functionality represented by icons 205, 515, which themselves were previously selected by user interaction. User interface 1400 is displayed by touchscreen 105 under the direction of electronic components housed in housing 110. The electronic components can include a data processing device that performs data processing operations, including directing touchscreen 105 to display user interface 1400.

In addition to icon 1305, user interface 1400 also includes a collection of icons 1405, 1410, 1415. Icons 1405, 1410, 1415 each represent an aspect of the functionality provided by electronic device 100. However, the aspects represented by 1405, 1410, 1415 are encompassed within the aspect of the functionality represented by icon 205, within the aspect of the functionality represented by icon 515, and within the aspect of the functionality represented by icon 1305. Icons 1405, 1410, 1415 can thus represent more specific, narrower instances of the relatively broader functionality represented by icons 205, 515, 1305. For example, in implementations where icon 205 represents an application, icon 515 represents a task within that application, and icon 1305 represents a first characteristic of the task within that application, icons 1405, 1410, 1415 can each represent different characteristics or features of that task within that application.

Icons 1405, 1410, 1415 are arranged on touch screen 105 around icon 1305. In some implementations, icons 1405, 1410, 1415 can surround icon 1305 completely (as shown). In other instances, icons 1405, 1410, 1415 can form a generally arc-shaped perimeter around the selected icon 1305. In either case, icon 1305 can be taken by a user as a seminal icon from which icons such as icons 1405, 1410, 1415 descend.

In addition to the arrangement of icons 1405, 1410, 1415 on touch screen 105, other graphical elements can be used to indicate that the aspects of the functionality represented by icons 1405, 1410, 1415 are encompassed within the aspect of the functionality represented by icons 205, 515, 1305. For example, in some implementations, icons 205, 515, 1305 can be displayed enlarged in size relative to their size prior to selection, relative to other icons, or relative to both. In other implementations, icons 205, 515, 1305 can be highlighted, colored, or otherwise labeled relative to their state prior to selection, relative to other icons, or relative to both. Icons 205, 515 are however omitted from the illustrative example of FIG. 14. In some implementations, user interface 1400 can include tendrils that couple icons 1405, 1410, 1415 to icon 1305 to visually represent that the aspects of the functionality represented by icons 1405, 1410, 1415 are encompassed within the aspect of the functionality represented by icon 1305.

As another example, the display of other icons on touchscreen 105 can be changed to ensure that this encompassment is visually apparent to a user. For example, icons 1205, 1210, 1215, 1220 can be omitted from user interface 1400 (as shown). In other implementations, icons 1205, 1210, 1215, 1220 can be shaded, colored, reduce in size, or otherwise labeled to indicate that the aspects of the functionality represented by icons 1405, 1410, 1415 are encompassed within the aspect of the functionality represented by icons 205, 515, 1305.

In some implementations, user interface 1400 can dynamically change to indicate that the aspects of the functionality represented by icons 1405, 1410, 1415 are encompassed within the aspect of the functionality represented by icons 205, 515, 1305. For example, icons 1405, 1410, 1415 can appear to originate from icon 1305 and move to positions arranged around icon 1305. In some implementations, icons 1405, 1410, 1415 can increase in size as they move further away from icon 1305.

In some implementations, user interface 1400 can dynamically change to present new icons that represent different aspects of the functionality of electronic device 100 that are encompassed within the aspect of the functionality represented by icons 205, 515, 1305.

In the illustrated implementation, icons 1405, 1410, 1415 are textual elements that identify the represented functionality the user. Selection of a particular icon 1405, 1410, 1415 can be translated by electronic device 100 into an indication that the user wishes to, e.g., perform the task represented by icon 515 in the application represented by icon 205 with respect to the individual represented by icons 1305 and having the characteristic or feature represented by the selected of icons 1405, 1410, 1415.

In the illustrated implementation, user interface 1400 does not display icons 205, 515 and a relatively large portion of touch screen 105 is available to display icons 1405, 1410, 1415. In other implementations, icons 205, 515 are also displayed and provide a user with a hierarchical perspective on the currently-selected functionality.

In general, the encompassed aspects of the functionality that are represented by icons (e.g., icons 1405, 1410, 1415) are selected by electronic device 100 for display based on the likelihood that the user wishes to access the respective encompassed aspects of the functionality, as described further below.

FIG. 15 is a flowchart of a process 1500 for determining the likelihood that a user wishes to access an aspect of the functionality provided by an electronic device. Process 1500 can be performed by an electronic device that includes one or more digital data processing devices that perform operations by executing one or more sets of machine-readable instructions, such as electronic device 100. Process 1500 can be performed in isolation or in conjunction with other digital data processing operations.

The electronic device performing process 1500 navigates to functionality in accordance with user interaction at 1505. For example, the electronic device can navigate to the functionality by presenting one or more of user interfaces 500, 600, 700, 800, 1200, 1300, 1400 and receiving user interaction indicating that an aspect of functionality represented by an icon is to be accessed. As another example, the electronic device can navigate to the functionality in other ways, such as by opening an application in response to a user selection of the application and then navigating to a task having particular characteristics in response to user interaction with one or more user interfaces presented by that application.

The electronic device performing process 1500 records an indicator of the access of the functionality at 1510. The indicator can be recorded in a data collection tangibly embodied on one or more data storage devices. The indicator can be stored in a variety of different data structures, including data tables, lists, arrays, and hierarchical structures.

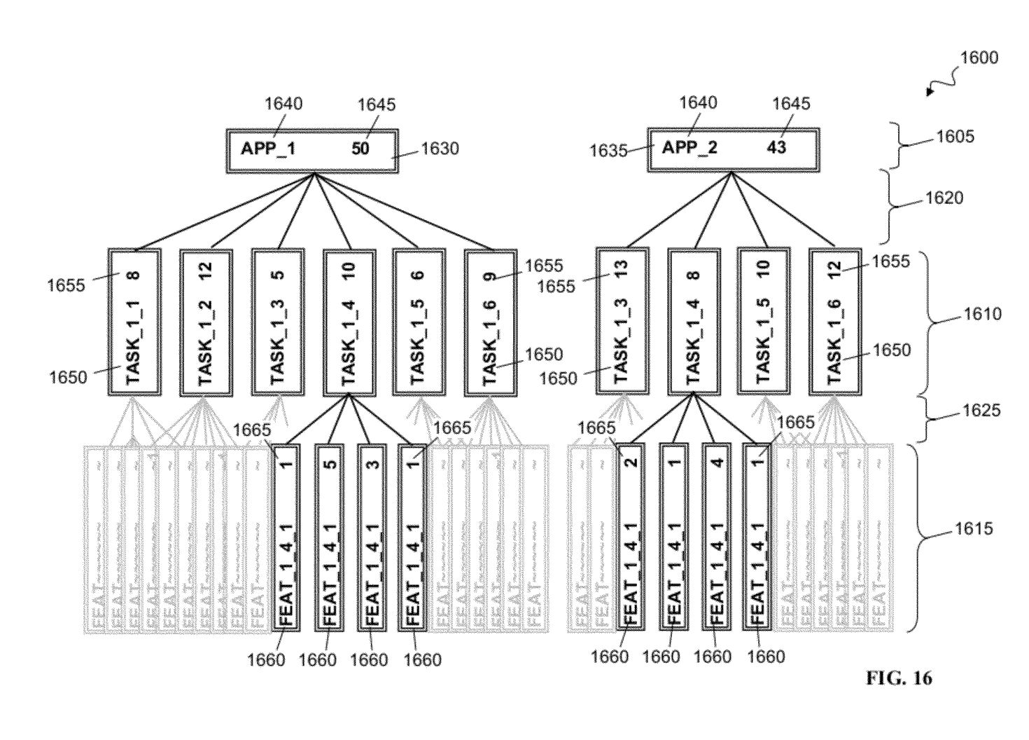

FIG. 16 is a schematic representation of one example of a hierarchical data collection 1600 that can store indicators characterizing previous access to the functionality provided by an electronic device. In the illustrated implementation, data collection 1600 includes a top level 1605, a second level 1610, and a third level 1615 that are joined by links 1620, 1625. In other implementations, data collection 1600 can include two levels or more than three levels.

Top level 1605 includes a collection of nodes 1630, 1635 that each includes an identifier 1640 of an application and an indication 1645 of how often that application was accessed. Indications 1645 can be, e.g., number counts of past accesses (as shown), frequency measures of past accesses, or weighted counts or frequency measures that overweight more recent accesses relative to earlier accesses. Nodes 1630, 1635 can be, e.g., records or elements in a list or array that are added to data collection 1600 as new applications are installed on an electronic device.

Second level 1610 includes nodes that descend from the respective of nodes 1630, 1635 in top level. The relationships between the nodes in second level 1610 and nodes 1630, 1635 are schematically represented as links 1620, which can be pointers or other logical associations. Each of the nodes in second level 1610 includes an identifier 1650 of a task within the application identified by the identifier 1640 from which that node descends and an indication 1655 of how often that task was accessed. Indications 1655 can be, e.g., number counts of past accesses (as shown), frequency measures of past accesses, or weighted counts or frequency measures that overweight more recent accesses relative to earlier accesses. The nodes in second level 1610 can be, e.g., records that are added one-by-one to data collection 1600 as new tasks are accessed.

Third level 1615 includes nodes that descend from respective nodes in second level 1610 and from the respective parent nodes 1630, 1635 in top level. The relationships between the nodes in third level 1615 and the nodes in second level 1610 are schematically represented as links 1625, which can be pointers or other logical associations. Each of the nodes in third level 1615 includes an identifier 1660 of a characteristic or feature of the task identified by the identifier 1650 in the node from which that node descends and an indication 1665 of how often that task was accessed with that feature or characteristic. Indications 1665 can be, e.g., number counts of past accesses (as shown), frequency measures of past accesses, or weighted counts or frequency measures that overweight more recent accesses relative to earlier accesses. The nodes in third level 1615 can be, e.g., records that are added one-by-one to data collection 1600 as the tasks identified in second level 1610 are accessed with different features or characteristics.

Returning to FIG. 15, the electronic device performing process 1500 can repeatedly navigate to different functionality and record indicators of the accesses to the functionality to assemble collection of such indicators, such as hierarchical data collection 1600. At some point, the electronic device performing process 1500 ranks the aspects of the functionality according to how often the aspects are accessed at 1515. The ranking can embody the frequency at which the aspects have been accessed in a variety of different ways in an attempt to determine the aspects which are most likely to be accessed by a user. For example, aspects of functionality that are accessed more often (i.e., at a higher frequency) can be ranked higher than aspects of functionality that are accessed less often (i.e., at a lower frequency). As another example, aspects of functionality that have been accessed more often in the relatively recent past can be ranked higher than aspects of functionality that were accessed more often in the relatively distant past.

The electronic device performing process 1500 displays icons that represent functionality according to this rank at 1520. The icons can be displayed, e.g., in one or more of user interfaces 500, 600, 700, 800, 1200, 1300, 1400. In such user interfaces, icons that represent functionality that is ranked higher can be given priority in a variety of different ways. For example, in some implementations, icons representing higher-ranked functionality can be displayed first on a user interface. As another example, icons representing higher-ranked functionality can be larger than icons representing lower-ranked functionality. As yet another example, icons representing higher-ranked functionality can be displayed for longer periods of time on a dynamic user interface. In a still further example, icons representing high-ranked functionality can be “promoted” to a different user interface.

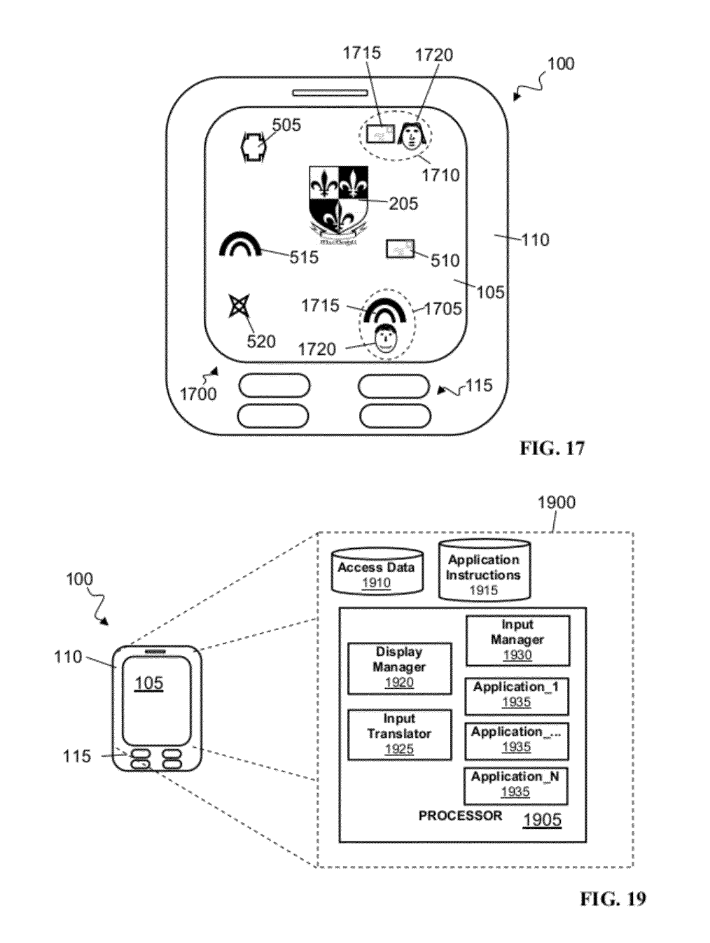

FIG. 17 is a schematic representation of an example of a user interface 1700 to which icons representing high-ranked functionality have been “promoted.” User interface 1700 can be displayed in response to user selection of icon 205 on touch screen 105. The user selection can be received over touch screen 105, over one or more input devices 115, or over combinations of touch screen 105 and one or more input devices 115. For example, the user interaction can be one of user interaction 210, 305, 405, 410 (FIGS. 2, 3, 4). User interface 1700 is displayed by touchscreen 105 under the direction of electronic components housed in housing 110. The electronic components can include a data processing device that performs data processing operations, including directing touchscreen 105 to display user interface 1700.

In addition to icons 205, 505, 510, 515, 520, user interface 1700 also includes a pair of promoted icons 1705, 1710. Promoted icons 1705, 1710 each represent an aspect of the functionality provided by electronic device 100. However, the aspect represented by promoted icon 1705 is encompassed within the aspect of the functionality represented by icon 515. The aspect represented by promoted icon 1710 is encompassed within the aspect of the functionality represented by icon 510. Thus, although promoted icons 1705, 1710 each represent more specific, narrower instances of the relatively broader functionality represented by the respective of icons 515, 510, promoted icons 1705, 1710 are displayed on touch screen 105 at the same time as icons 515, 510. In some cases, the aspects represented by multiple promoted icons are encompassed within a single broader aspect of the functionality.

In the illustrated implementation, promoted icons 1705, 1710 each include a pair of indicia 1715, 1720 that together identify the represented functionality. For example, in some implementations, indicium 1715 can identify a task within an application represented by icon 205, whereas indicium 1720 can identify a feature of that task such as, e.g., the individual to whom an e-mail is to be sent or to whom a call is to be placed. In other implementations, promoted icons 1705, 1710 include a single indicium.

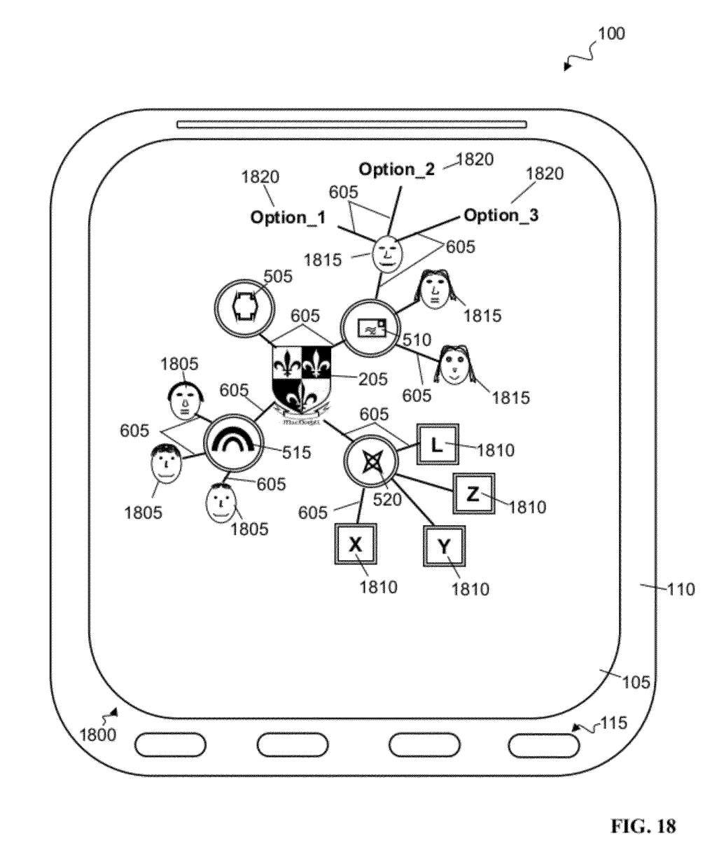

FIG. 18 is a schematic representation of an example of a user interface 1800 displayed in response to user selection of icon 205 on touch screen 105. The user selection can be received over touch screen 105, over one or more input devices 115, or over combinations of touch screen 105 and one or more input devices 115. For example, the user interaction can be one of user interaction 210, 305, 405, 410 (FIGS. 2, 3, 4). User interface 1800 is displayed by touchscreen 105 under the direction of electronic components housed in housing 110. The electronic components can include a data processing device that performs data processing operations, including directing touchscreen 105 to display user interface 1800.

In addition to icons 205, 505, 510, 515, 520, user interface 1800 also includes various collections of icons 1805, 1810, 1815, 1820. Icons 205, 505, 510, 515, 520, 1805, 1810, 1815, 1820 each represent an aspect of the functionality provided by electronic device 100. However, the aspects represented by icons 505, 510, 515, 520 are encompassed within the aspect of the functionality represented by icon 205. The aspects represented by icons 1805 are encompassed within the aspect of the functionality represented by icons 205, 515. The aspects represented by icons 1810 are encompassed within the aspect of the functionality represented by icons 205, 520. The aspects represented by icons 1815 are encompassed within the aspect of the functionality represented by icons 205, 510. The aspects represented by icons 1820 are encompassed within the aspects of the functionality represented by icons 205, 510, and a first of icons 1815. User interface 1800 thus includes icons representing more than two (i.e., four) different levels of aspects of the functionality provided by device 100. For example, in implementations where icon 205 represents an application, icons 505, 510, 515, 520 can represent tasks with which the application is designed to assist a user, and icons 1805, 1810, 1815, 1820 can represent characteristics or features of the performance of those tasks. In the illustrated implementation, respective of icons 205, 505, 510, 515, 520, 1805, 1810, 1815, 1820 are coupled together by tendrils 605 that visually represent the relationship between the functionality represented by the coupled icons.

In some implementations, user interface 1800 can dynamically change over time. For example, in some implementations, icons 505, 510, 515, 520 may appear to germinate over time from a seminal icon 205. Icons 1805 may appear to germinate over time from a seminal icon 515. Icons 1810 may appear to germinate over time from a seminal icon 520. Icons 1815 may appear to germinate over time from a seminal icon 510. Icons 1820 may appear to germinate over time from a seminal of the icons 1815. As another example, in some implementations, user interface 1800 can dynamically change over time to display new icons that represent different aspects of the functionality of electronic device 100. Examples of displays of new icons are described above.

As shown, a large battery of different aspects of functionality can be represented on touch screen 105. Further, the relationships between the represented aspects of functionality can be intuitively grasped by a user. Further, the icons which are displayed can represent aspects of the functionality of device 100 that are relatively likely to be accessed by a user. Moreover, in some implementations, aspects of functionality can be promoted between levels to reflect the high likelihood of being accessed.

FIG. 19 is a schematic representation of a collection 1900 of electronic components in device 100 that can implement touch screen user interfaces such as user interfaces 500, 600, 700, 800, 1200, 1300, 1400, 1700, 1800.

Electronic component collection 1900 includes a digital data processor 1905, a store for access data 1910, and a store for application instructions 1915. Digital data processor 1905 is a system of one or more data processing devices that perform operations in accordance with one or more sets of machine-readable instructions. For example, digital data processor 1905 performs operations in accordance with the instructions for implementing various applications stored in application instruction store 1915. Among the applications that can be implemented by digital data processor 1905 are a display manager 1920, a drawn user input translator 1925, an input manager 1930, and one or more other applications 1935. Processor 125 can be implemented using digital electronic circuitry, or in computer software, firmware, hardware, or combinations thereof.

Display manager 1920 is a software component that is configured to present content, including user interfaces such as user interfaces 500, 600, 700, 800, 1200, 1300, 1400, 1700, 1800, on touch screen 110. Display manager 1920 can receive content from a number of sources and may determine the details as to how the content is to be presented to a user.

Drawn user input translator 1925 is a software component that is configured to interpret user interaction with touch screen 110. For example, input translator 1925 can determine whether to interpret user interaction with user interfaces such as user interfaces 500, 600, 700, 800, 1200, 1300, 1400, 1700, 1800 as a command that a particular aspect of the functionality provided by device 100 is to be accessed or as a command that a particular aspect of the functionality provided by device 100 is to be accessed or as a command that icons representing functionality encompassed by particular aspect of such functionality are to be displayed. In some implementations, drawn user input translator 1925 can be tailored to interpret a particular individuals user interaction in accordance with personalized settings, through machine learning, or other techniques. In some implementations, drawn user input translator 1925 can access both default and user-specific rules for interpreting user interaction as characters. The rules can be stored in one or more data storage devices of device 100.

Input manager 1930 is a software component that is configured to implement commands responsive to user interaction with various input elements of device 100 using control signals that can be interpreted by other components in collection 1900. Such commands be input, e.g., over input elements 115 or touch screen 110. For example, input manager 1930 can place a call to a phone contact, access a resource available on the Internet, present a screen for authoring electronic mail, or start an application in response to a command responsive to user interaction.

Applications 1935 are other software components that are performed by digital data processor 125 and implement at least some of the functionality provided by device 100. The performance of applications 1935 by digital data processor 125 can be initiated in response to user interaction with user interfaces such as user interfaces 500, 600, 700, 800, 1200, 1300, 1400, 1700, 1800. Applications 1935 may take a variety of forms, such as mapping applications, e-mail and other messaging applications, web browser applications, music and video players, and various applications running within a web browser or running extensions of a web browser.

In some implementations, electronic component collection 1900 also includes a wireless or other communication network interface. A wireless interface is a device configured to manage communication with a wireless network, which may be a data network that also carries voice communications. A wireless interface can provide for communication by the device 100 with messaging services such as text messaging, e-mail, and telephone voice mail messaging and with a server system.

In some implementations, electronic device 100 uses such a communication network interface to access remotely stored data that is used to form user interfaces such as user interfaces 500, 600, 700, 800, 1200, 1300, 1400, 1700, 1800. For example, application data, contact data, media data, and/or indicators characterizing previous access to the functionality provided by electronic device 100 can be stored remotely from electronic device 100. In some implementations,

Access data store 1910 is a collection of data that characterizing the functionality provided by an electronic device and previous access to that functionality. For example, access data store 1910 can include data collection 1600 (FIG. 16). Access data store 1910 is generally stored locally at device 100, as shown. In other implementations, access data store 1910 can be stored in whole or in part on another electronic device, such as a desktop computer with which a portable device 100 is occasionally synchronized or in a remote data server that is accessed using a wireless or other interface.

Application instruction store 1915 is a collection of machine-readable instructions that can be implemented by processor 1905, including display manager 1920, input translator 1925, input manager 1930, and applications 1935. Access data store 1910 and application instruction store 1915 may be stored separately or together in one or more persistent data storage devices.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular implementations of the subject matter have been described. Other implementations are within the scope of the following claims. For example, although these illustrative examples are described in the context of particular user interactions with icons, other examples of user interaction with other icons can also be treated as described above.

What is claimed is:

1. An electronic device comprising:
one or more data processing devices; and
a touch screen coupled to the one or more data processing devices to display a user interface under the direction thereof, the user interface comprising:
a first icon representing an aspect of the functionality provided by the electronic device, and
a collection of three or more icons each representing a respective relatively narrower aspect of the functionality provided by the electronic device, the aspects represented by the three or more icons in the collection being relatively narrower than and encompassed within the aspect represented by the first icon, the three or more icons arranged generally around the first icon on the touch screen,
wherein the one or more data processing devices are programmed to interpret at least some user selections of one of the three or more icons as a command to access the respective aspect of the functionality represented by the selected one of the three or more icons,
wherein the user interface, under the direction of the one or more data processing devices, dynamically changes to display the three or more icons in the collection moving outwardly away from the first icon.

2. The electronic device of claim 1, wherein:
the first icon represents an application that can be performed by the electronic device; and
the icons in the collection represent tasks within the application represented by the first icon; and
the one or more data processing devices are programmed to interpret the at least some user selections as a command to open the application directly to the task represented by the selected one of the icons.

3. The electronic device of claim 1, wherein the user interface further comprises a second collection of icons each representing a respective aspect of the functionality provided by the electronic device, the aspects represented by the icons in the second collection being relatively narrower than and encompassed within an aspect represented by a respective icon in the collection of three or more icons, the icons in the second collection being arranged on the touch screen generally around the respective icon in the collection of three or more icons.

4. The electronic device of claim 1, further comprising a persistent memory comprising one or more data storage devices, the persistent memory comprising identifiers of different aspects of functionality offered by the electronic device and associated indications of how often the different aspects of the functionality were previously accessed.

5. The electronic device of claim 1, wherein the three or more icons in the collection completely surround the first icon.

6. The electronic device of claim 1, wherein the three or more icons in the collection are arranged in a generally arc-shaped perimeter around the first icon.

7. (canceled)

8. The electronic device of claim 1, wherein the three or more icons in the collection are coupled to the first icon by graphical elements.

9. The electronic device of claim 8, wherein the graphical elements are generally branch-shaped and show the icons in the collection germinating from a seminal first icon.

10. The electronic device of claim 1, wherein the user interface, under the direction of the one or more data processing devices, dynamically changes to display one or more new icons, each of the new icons representing an aspect of the functionality provided by the electronic device, the aspects of the functionality represented by the new icons differing from and being relatively narrower than the aspects of the functionality represented by the icons in the collection.

11. An electronic device comprising:
one or more data processing devices;
a touch screen coupled to the one or more data processing devices to display a user interface under the direction thereof, the user interface comprising:
a first icon representing an application available on the electronic device, and
a collection of three or more icons each representing a different task in the application, the three or more icons arranged generally around the first icon on the touch screen; and
a persistent memory comprising one or more data storage devices, the persistent memory comprising
identifiers of the tasks represented by the icons in the collection,
identifiers of other tasks in the application, and
associated indications of how often the tasks identified by the identifiers were previously accessed, wherein the associated indications indicate that the tasks represented by the icons in the collection were accessed more often than the other tasks in the application
wherein the one or more data processing devices are programmed to direct the touch screen to:
dynamically move the collection of three or more icons outwardly away from the first icon; and
display new icons representing the other tasks in the application.

12. (canceled)

13. A method implemented by an electronic device comprising a one or more data processing devices and a touch screen coupled to the one or more data processing devices to display a user interface under the direction thereof, the method comprising:
displaying, on the touch screen, icons, each icon representing a different application available on the electronic device;
receiving, over an input device, a first user selection of a first of the icons representing a first of the applications;
determining, using the one or more data processing devices, whether the first user selection is a command to open the first application or whether the first user selection is a command to display additional icons each representing a task within the first application; and
in response to determining that the first user selection is a command to display additional icons, displaying, on the touch screen, a collection of three or more icons each representing a different task in the first application, the three or more icons arranged on the touch screen generally around the first icon,
wherein the touch screen, under the direction of the one or more data processing devices, dynamically changes to display the icons in the collection moving outwardly away from the first icon.

14. (canceled)

15. The method of claim 13, further comprising:
receiving, over an input device, a second user selection of an icon in the collection and representing the task in the first application.

16. The method of claim 15, further comprising:
in response to the second user selection, displaying, on the touch screen, a second collection of icons each representing a different characteristic or feature of the task represented by the selected icon.

17. The method of claim 16, wherein the icons in the second collection are arranged on the touch screen generally around the selected icon.

18. The method of claim 15, further comprising:
in response to the second user selection, navigating to a user interface of the application for performance of the task represented by the selected icon independently of additional user interaction.

19. A computer storage medium encoded with a computer program, the program comprising instructions that when executed by one or more data processing devices of an electronic device cause the one or more data processing devices to perform operations, the operations comprising:
displaying, on a touch screen, interactive icons each representing a different application available on the electronic device;
receiving, over the touch screen, a first user selection of a first of the icons representing a first of the applications;
in response to the receipt of the first user selection, displaying a collection of three or more icons each representing a different task in the first application, the three or more icons arranged generally around the first icon on the touch screen, wherein the touch screen, under the direction of the one or more data processing devices, dynamically changes to display the icons in the collection moving outwardly away from the first icon;
receiving, over the touch screen, a second user selection of a second of the icons in the collection; and
in response to the receipt of the second user selection, navigating to a user interface of the application for performance of the task represented by the selected icon independently of additional user interaction.

20. The electronic device of claim 1, wherein the icons in the collection appear to originate from the first icon and move to positions around the first icon.

21. The electronic device of claim 1, wherein the icons in the collection appear to increase in size as they move further away from the first icon.

22. The electronic device of claim 1, wherein the collection of three or more icons includes a promoted icon that represents an aspect of the functionality provided by the electronic device that is encompassed within the functionality represented by another icon in the collection of three or more icons.

23. The electronic device of claim 11, wherein the user interface dynamically moves the collection in response to a tap and hold gesture received on a portion of the touch screen displaying the first icon.

24. The electronic device of claim 11, wherein the icons in the collection appear to originate from the first icon and move to positions around the first icon.

25. The electronic device of claim 11, wherein the icons in the collection appear to increase in size as they move outwardly away from the first icon.

26. The method of claim 13, wherein:
receiving the first user selection comprises receiving a tap and hold gesture selecting the first of the icons, and
receiving the second user selection comprises receiving a generally line-shaped stroke that is drawn from the first of the icons to the icon representing the task.

27. The computer storage medium of claim 19, wherein:
receiving the first user selection comprises receiving a tap and hold gesture selecting the first of the icons; and
receiving the second user selection comprises receiving a generally line-shaped stroke that is drawn from the first of the icons to the icon representing the task.
